(19) United States
(12) Patent Application Publication
(10) Pub. No.: US 2025/0326450 A1
(43) Pub. Date: Oct. 23, 2025

(54) HITCH WITH DEFORMABLE STOPPER

(71) Applicant: Caterpillar Inc., Peoria, IL (US)

(72) Inventors: Shankar SHANMUGAM, Adyar, Chennai (IN); Steven D. SPRINGER, Naperville, IL (US)

(73) Assignee: Caterpillar Inc., Peoria, IL (US)

(21) Appl. No.: 18/642,547

(22) Filed: Apr. 22, 2024

(51) Int. Cl. B62D 53/02

(52) U.S. Cl. CPC B62D 53/02

(57) ABSTRACT

A hitch for a vehicle includes a first side, a second side opposite the first side, a circular opening between the first side and the second side, and a first axis extending perpendicular to the circular opening. The hitch further includes a first articulation stop on the second side of the hitch and extending from the hitch, parallel to the axis, a cavity within the first articulation stop, the cavity defining a floor, and a deformable stopper within the cavity extending away from the floor of the cavity past a distal end of the first articulation stop. The deformable stopper is configured to deform within the cavity.

### TECHNICAL FIELD

The present disclosure relates generally to connection devices for vehicles, and more particularly, to a hitch for a vehicle.

### BACKGROUND

Some large vehicles include multiple segments, such as front and rear frames, that are connected to each other. A hitch can be used to connect the multiple segments together while also allowing the segments to pivot, facilitating turns. Some hitches allow at least some rotation of the segments, for example allowing segments to tilt individually when traversing uneven terrain.

In some vehicles, one of the segments can pivot about the hitch to a point where the segments collide. To reduce the likelihood that these collisions cause damage, some hitches include protrusions that limit the range of motion of one or more of the segments. To limit metal-on-metal contact between the protrusions of the hitch and the segments, the vehicles sometimes include additional structures that are designed to absorb the energy of an impact. These structures, however, are susceptible to wear and damage due to over deformation and high impact forces.

U.S. Pat. No. 6,957,823 B1, issued on Oct. 25, 2005 (“the '823 patent”), describes a hitch assembly including a stop for limiting the movement of a cradle assembly. The stop includes a front stop for limiting fore movement of the cradle assembly and a rear stop for limiting aft movement of the cradle assembly. Each stop includes a pair of rubber bumpers attached to the frame via a bracket or similar mechanism. The '823 patent does not describe a structure for preventing over-deformation of the rubber stops.

The hitch of the present disclosure may solve one or more of the problems set forth above and/or other problems in the art. The scope of the current disclosure, however, is defined by the attached claims, and not by the ability to solve any specific problem.

### SUMMARY

In one aspect, a hitch for a vehicle may include a first side, a second side opposite the first side, a circular opening between the first side and the second side, and a first axis extending perpendicular to the circular opening. The hitch may further include a first articulation stop on the second side of the hitch and extending from the hitch, parallel to the axis, a cavity within the first articulation stop, the cavity defining a floor, and a deformable stopper within the cavity extending away from the floor of the cavity past a distal end of the first articulation stop. The deformable stopper may be configured to deform within the cavity.

In another aspect, a hitch for connecting a first frame of a vehicle to a second frame of the vehicle may include a first side, a second side opposite the first side, a circular opening between the first side and the second side, and a first axis extending perpendicularly to circular opening. The hitch may further include first and second pivot mounts, first and second steering mounts, an oscillation stop extending outward from the hitch with respect to the circular opening, and first and second articulation stops on the second side of the hitch and extending away from the hitch, parallel to the axis. The hitch may further include first and second cavities within the first and second articulation stops, respectively, and first and second deformable stoppers within the respective cavities, the first and second deformable stoppers each extending away from an interior floor of the respective cavity past a distal end of the corresponding articulation stop. The first and second deformable stoppers may be configured to deform within the respective cavities when depressed.

In yet another aspect, a vehicle may include a first frame, a second frame, and a hitch rotatably coupled to the first frame and pivotally coupled to the second frame. The hitch may include a first side, a second side opposite the first side, a circular opening between the first side and the second side, and a first axis extending perpendicular to circular opening. The hitch may further include first and second pivot mounts, first and second steering mounts, an oscillation stop extending radially outward from the hitch, the oscillation stop having sloped sides configured to form contact surfaces with the vehicle. The vehicle may further include an articulation stop configured to limit pivoting movement of the first frame relative to the second frame.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of vehicle having a hitch, according to aspects of the disclosure.

FIG. 2 is a schematic top view of the vehicle and hitch of FIG. 1.

FIG. 3 is a schematic bottom view of the vehicle and hitch of FIG. 1.

FIG. 4 is a rear perspective view of the hitch of FIG. 1.

FIG. 5 is a front perspective view of the hitch of FIG. 1.

FIG. 6 is an enlarged cross-sectional view of the hitch of FIG. 1.

FIG. 7 is a rear view of the hitch of FIG. 1.

FIG. 8 is a top view of a vehicle having a hitch, according to aspects of the disclosure.

FIG. 9A is an enlarged cross-sectional view of articulation stop of the hitch of FIG. 1, before the stopper is depressed.

FIG. 9B is an enlarged cross-sectional view of the articulation stop of the hitch of FIG. 1, after the stopper is depressed.

FIG. 10 is an enlarged bottom perspective view of a vehicle having a hitch, according to aspects of the disclosure.

FIG. 11 is an enlarged rear view of the vehicle and hitch of FIG. 10.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

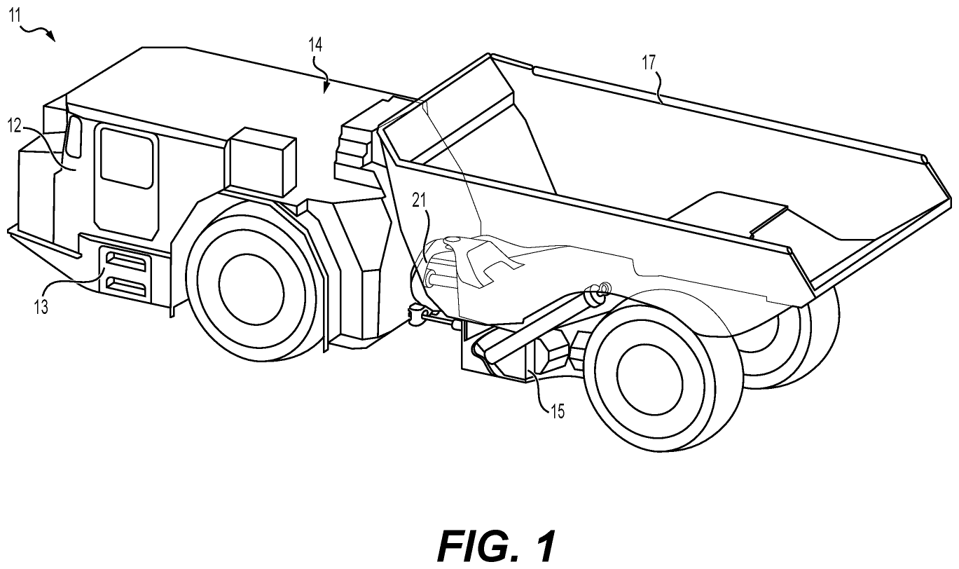

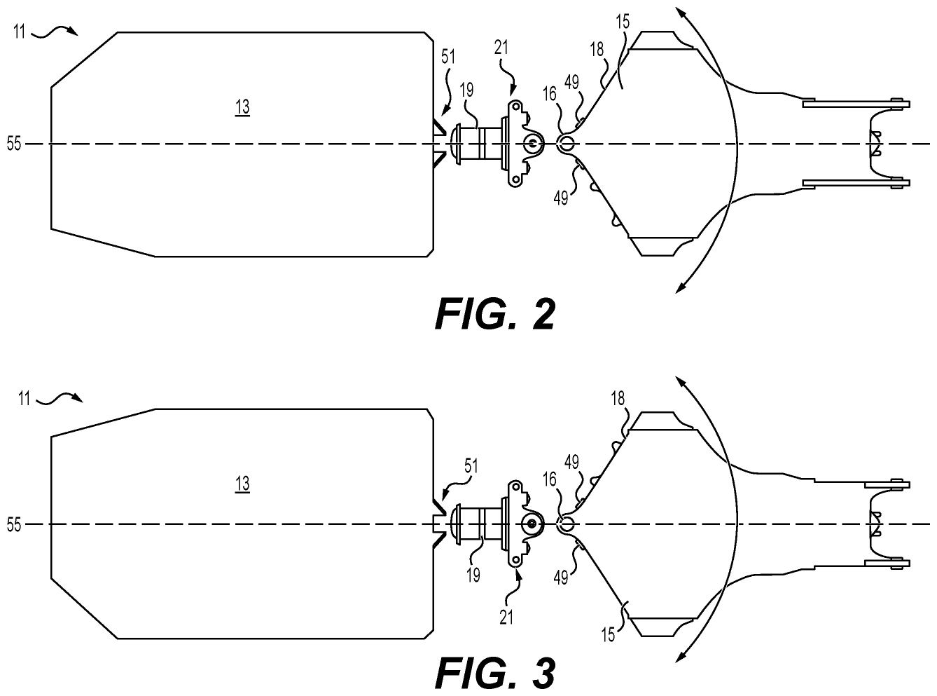

FIG. 1 provides a perspective view, and FIGS. 2-3 provide top and bottom schematic views, respectively, of a vehicle 11 having a hitch 21 according to aspects of the present invention. As will be explained in more detail below, the hitch 21 may allow a rear frame 15 of the vehicle 11 to rotate and pivot relative to a front frame 13 of the vehicle 11. The hitch 21 provides a device for limiting and absorbing the energy of the rear frame 15 relative to the front frame 13 while helping to prevent wear.

Referring to FIG. 1, the hitch 21 may connect the front frame 13 of the vehicle 11 to the rear frame 15 of the vehicle 11. The front frame 13 may support a cabin 12 and a propulsion system 14 for the vehicle 11, which is represented by a haul truck in FIG. 1. The rear frame 15 may support a bucket 17 for transporting and dumping material.

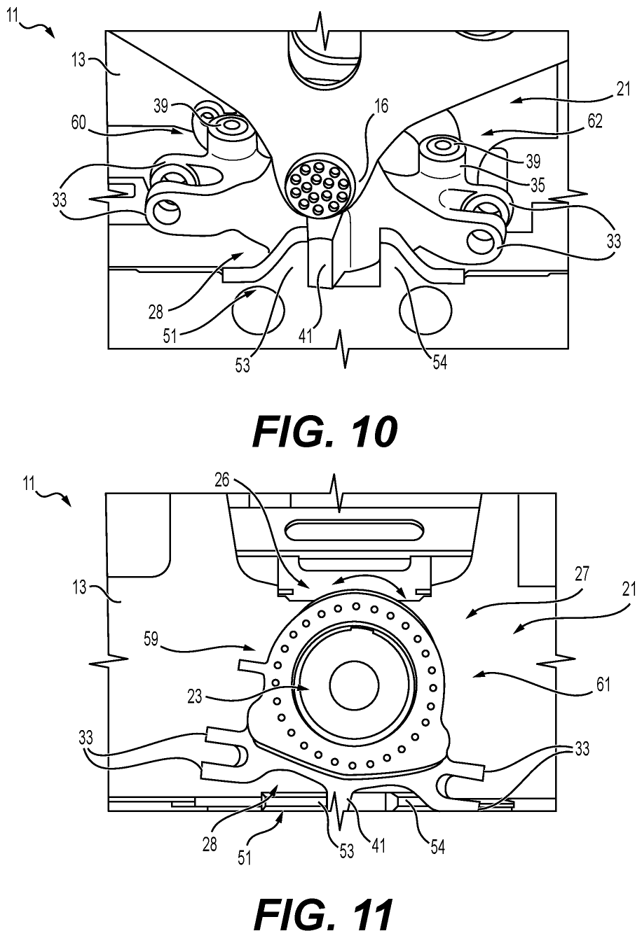

As shown in FIGS. 2-3, a generally cylindrical mount 19, or mount tube, may couple the front frame 13 to the hitch 21. A first end of the mount 19 may be rotatably held within the front frame 13, such that the mount 19 may rotate relative to the front frame 13 about a first axis, rotation axis 55, aligned with the longitudinal axis of the of the mount 19, while being axially locked along rotation axis 55 with respect to the front frame 13. The second end of the mount 19 may connect to a front side 25 (FIG. 5) of the hitch 21, such that the hitch 21 may rotate about the rotation axis 55 while remaining axially locked with respect to the front frame 13. As seen in FIGS. 2-3, the front frame 13 may further include a front frame stop 51 on the bottom of the front frame 13 having a triangular left flange 53 and a triangular right flange 54 (FIGS. 10-11). The “U” shaped open end of the bottom of the front frame may extend towards the hitch 21 and be positioned so as to limit the movement of an oscillation stop 41 (FIG. 5) of the hitch 21, further described below.

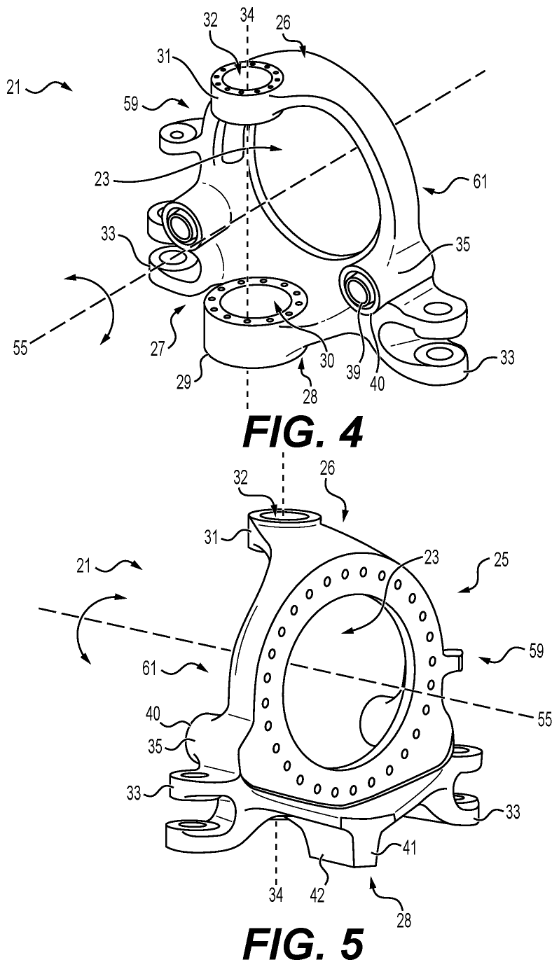

The rear frame 15 may include a generally “V” shaped front end 18 that tapers forward from a central portion of the rear frame 15 toward flanges 16 on the top and bottom sides of the rear frame 15. One or more bolts may extend through the flanges 16 to pivotally connect the rear frame 15 to the back side 27 (FIG. 4) of the hitch 21 such that the rear frame 15 may pivot around a second axis, articulation axis 34 (FIGS. 4-5). The rear frame 15 may pivot in the direction of the arrows extending across the rear frame 15 in FIGS. 2-3 when turning, for example. The front end 18 of the rear frame 15 may further include rear frame stops 49 that protrude normally away from a plane formed by the tapered front end 18.

The hitch 21 may be compatible with vehicles 11 in which the mount 19 connected to the front frame 13, as shown in FIGS. 2 and 3, and vehicles 11 in which the mount 19 is connected to the rear frame 15. The hitch 21 may be placed in a first position, the position shown in FIGS. 2-3, to connect to a mount 19 received with the front frame 13. In vehicles 11 with mount 19 connected to the rear frame 15, the hitch 21 may be rotated to a second position, 180 degrees from the first position depicted in FIGS. 2-3. When in the second position, the hitch 21 may be configured to interact with a frame stop 51 formed on the rear frame 15 and frame stops 49 formed on the front frame 13.

FIGS. 4-5 show a rear perspective view and a front perspective view of the hitch 21, respectively. The hitch 21 may have a first side, front side 25 (FIG. 5), that is opposite a second side, back side 27 (FIG. 4). The hitch 21 may be generally circular in shape, and may have a circular opening 23 between the front side 25 and the back side 27 of the hitch 21. The rotation axis 55 extends through, and perpendicular to, the circular opening 23.

The hitch 21 may further include a first pivot mount, bottom pivot mount 29, at a bottom end 28 of the hitch 21, and a second pivot mount, top pivot mount 31, at a top end 26 of the hitch 21. The hitch 21 may have a first lateral side, left side 59, and a second lateral side, right side 61. The hitch 21 may further include first and second steering mounts 33. In the illustrated example, two steering mounts are present on each of the left side 59 and the right side 61. First and second articulation stops 35 are also shown on the left side 59 and the right side 61, respectively, of the hitch 21. As shown in FIG. 5, the hitch 21 may have a wedge-shaped oscillation stop 41 on the bottom end 28 extending radially away from the circular opening 23.

The bottom pivot mount 29 and the top pivot mount 31 may be positioned on the back side 27 of the hitch, and angularly spaced 180 degrees apart relative to the circular opening 23. The bottom pivot mount 29 may have a bottom pivot opening 30, and the top pivot mount 31 may have a top pivot opening 32. The bottom pivot opening 30 and top pivot opening 32 may be arranged such that the articulation axis 34 runs through both the bottom pivot opening 30 and the top pivot opening 32, perpendicular to the rotation axis 55.

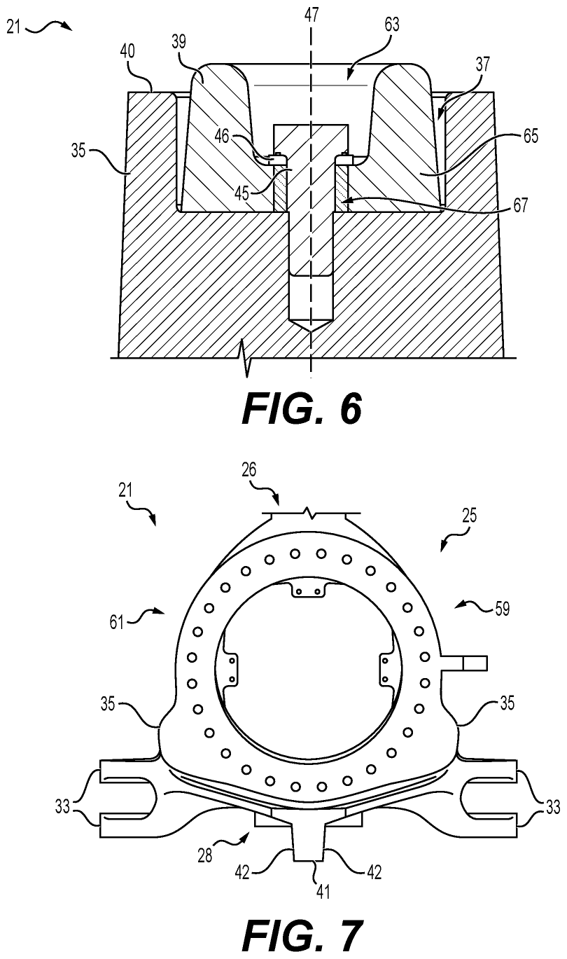

The articulation stops 35 may each be formed as a generally cylindrical protrusion that extends rearward away from the back side 27 of the hitch 21, in a direction that is parallel to the rotation axis 55. At least one articulation stop 35 is on the left side 60 and at least one articulation stop 35 is on the right side 62. In example embodiments, multiple articulation stops may be on each of the left side 60 and/or the right side 62. A deformable stopper 39 may be secured so as to protrude beyond a distal end 40 of each articulation stop 35. The deformable stopper 39 may be secured within the interior of a cavity 37 (FIG. 6), as described below. As used herein, the distal direction of the articulation stops 35 is a direction extending generally away from the floor of the cavity 37 (FIG. 6), this direction also being parallel to the rotation axis 55. The proximal direction refers to the direction that is opposite to the distal direction.

As seen in FIG. 5, the front side 25 of the hitch 21 may be primarily flat, so as to facilitate the mating of the hitch 21 to a flange of the mount 19. The oscillation stop 41 may include lateral sides 42, and may protrude in a direction opposite the articulation stops 35 so as to contact corresponding features (e.g., front end stops 51, shown in FIGS. 10-11) on the front frame 13 to limit the amount of tilt or rotation between the front frame 13 and the rear frame 15. The oscillation stop 41 may be aligned with the bottom pivot mount 29 and the top pivot mount 31, such that stop 41, mount 29, and mount 31 are at the same lateral position, at substantially the center of the circular opening 23, in a lateral direction.

FIG. 6 shows an enlarged cross-sectional view of the hitch 21, showing the distal end 40 of the articulation stop 35. The cavity 37 of the articulation stop 35 may be cylindrical in shape and have a longitudinal axis aligned with a third axis, stop axis 47, the stop axis 47 being parallel to the rotation axis 55. The deformable stopper 39 may extend from the interior floor of the cavity 37, through and past the distal end 40 of the articulation stop 35. In some embodiments, less than half the length of the deformable stopper 39 may extend past the distal end 40 of the articulation stop 35. In other embodiments, less than a third of the length of the deformable stopper 39 may extend past the distal end 40 of the articulation stop 35.

The deformable stopper 39 may be cylindrical or frustoconical in shape, a frustoconical shape being shown in FIG. 6. Other suitable shapes for the deformable stopper 39 include, for example, half-spherical and rectangular shapes. The deformable stopper 39 may define a longitudinal axis that is aligned with the articulation axis 34. The outer diameter of the deformable stopper 39 may decrease from the proximal end of the deformable stopper 39 to a distal end of the deformable stopper 39. The distal portion of the deformable stopper 39 may include a tapered opening 63 extending proximally from the distal end of the deformable stopper 39. The inner radius of the deformable stopper 39, which defines the lateral edges of the tapered opening 63, may increase from the proximal end of the tapered opening 63 to the distal end of the tapered opening 63. The tapered shape of the deformable stopper 39 may provide a thicker base with a thinner distal portion. This may facilitate the transfer of force and allow deformation to occur in a predictable and repeatable manner.

To facilitate removal of the deformable stopper 39, the proximal portion of the deformable stopper 39 may include a base 65 having a central bore 67 centered about the articulation axis 34. A bolt 45 extending through the central bore 67 may couple the deformable stopper 39 to the articulation stop 35. A washer 46 may be secured between the bolt 45 and the base 65. While a removable fastener is shown in FIG. 6, in other embodiments, the deformable stopper 39 may be couple to the articulation stop 35 by another suitable means.

In some embodiments, the deformable stopper 39 may be made from a resilient material that is adapted to withstand large forces. Examples of suitable materials include an elastomer material, such as synthetic rubber or natural rubber. In other embodiments, the deformable stopper 39 may be made from another shock-absorbing material.

FIG. 7 shows a front view of the hitch 21. As shown in FIG. 7, the oscillation stop 41 may be wedge-shaped such that the sloped lateral sides 42 of the oscillation stop 41 taper with increased radial distance from the circular opening 23. The steering mounts 33 may extend laterally from both the left side 59 and right side 61 of the hitch 21, positioned between the oscillation stop 41 and the articulation stops 35 on either side. Steering arms (not shown) may extend from the rear frame 15 and connect to the steering mounts 33.

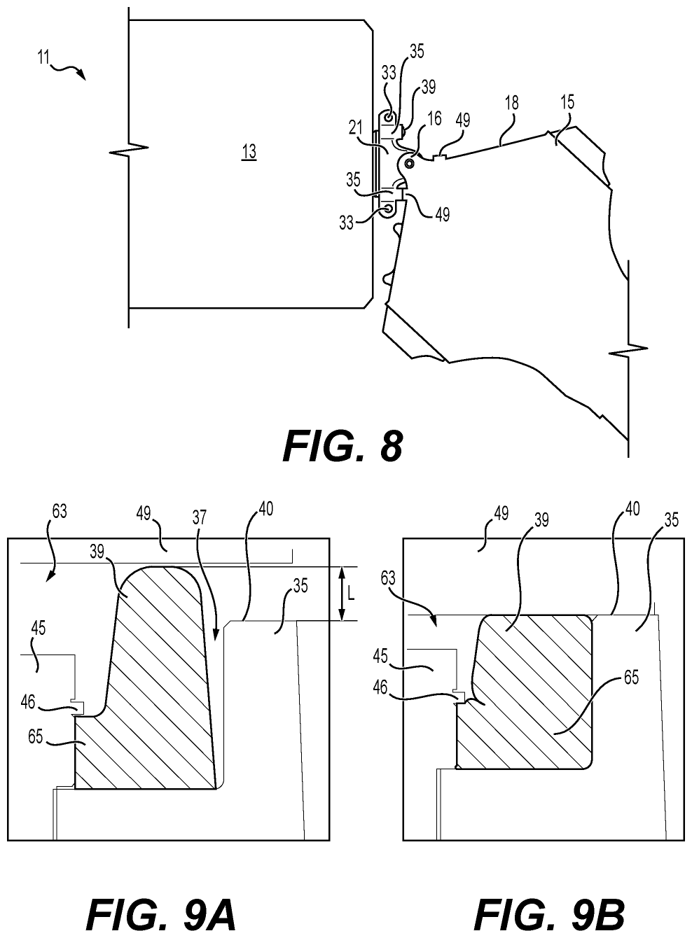

As shown in FIG. 8, the rear frame 15 may be coupled to the hitch 21 such that the rear frame 15 may laterally pivot, or articulate, relative to the hitch 21 about the articulation axis 34 (FIGS. 4-5) of the hitch 21. The articulation stops 35 limit the angular range through which the rear frame 15 may pivot.

FIG. 8 shows a top view of the vehicle 11, according to aspects of the disclosure. With reference to FIG. 8, as the rear frame 15 approaches the front frame 13 (e.g., when the vehicle 11 makes a turn), the left-most rear frame stop 49 may encounter the deformable stopper 39 extending from the articulation stop 35 on the left side of the hitch 21. As the rear frame 15 moves closer towards the front frame 13, the rear frame stop 49 begins to depress the deformable stopper 39, causing it to deform (e.g., compress). The deformation of the deformable stopper 39 damps the motion of the rear frame 15 towards the front frame 13, dissipating the energy of the rear frame 15. If the rotation of the rear frame 15 is great enough, the left most rear frame stop 49 may contact the distal end 40 (FIG. 4) of the left most articulation stop 35, forming a ring of contact in a plane between the rear frame stop 49 and the articulation stop 35 as the flat distal end 40 contacts a flat surface of the rear frame stop 49 of the front frame 13.

FIGS. 9A and 9B are enlarged cross-sectional views of the distal end 40 of an articulation stop 35 before and after being depressed, respectively, by the rear frame stop 49. As shown in FIG. 9A, before being deformed by the rear frame stop 49, the deformable stopper 39 extends past the distal end 40 of the articulation stop 35 by a length L. As described above, length L may be defined such that less than half of the total length of the deformable stopper 39 extends past the distal end 40 of the articulation stop 35. The rear frame stop 49 may depress the deformable stopper 39 until the rear frame stop 49 contacts the distal end 40 of the articulation stop 35, fully containing the deformable stopper 39 in the cavity 37, as shown in FIG. 9B.

As articulation stop 35 is depressed, the deformable stopper 39 is compressed proximally into the cavity and expands radially inward into the tapered opening 63. The deformable stopper 39 also expands radially outward until reaching the wall and filling the cavity 37. Once the rear frame stop 49 reaches and contacts the distal end 40 of the articulation stop 35, the distal end of the deformable stopper 39 may be flush with the distal end 40 of the articulation stop 35, and the deformable stopper may be fully contained within the cavity 37. As such, the deformation of the deformable stopper 39 is limited by the cavity 37 and by the interaction of the rear frame stop 49 with the distal end 40 of the articulation stop 35. In some embodiments, the dimensions of the deformable stopper 39 and the distance which the deformable stopper 39 extends past the distal end 40 of the articulation stop 35 (e.g., length L) may be chosen to ensure that the articulation stop 35 undergoes elastic deformation, as opposed to plastic deformation.

FIGS. 10-11 are an enlarged bottom perspective view and an enlarged rear view, respectively, of the vehicle 11, according to aspects of the disclosure. As shown in FIGS. 10-11, the hitch 21 may be rotatably coupled to the front frame 13 such that the hitch 21 and coupled rear frame 15 may rotate relative to the front frame 13 about the rotation axis 55 (FIGS. 4-5) (e.g., due to the vehicle 11 traversing uneven terrain). The oscillation stop 41 limits the angular range through which the hitch 21 and coupled rear frame 15 may rotate in relation to the front frame 13.

As shown in FIGS. 10-11, the hitch 21 may rotate to a maximum allowable angle in a clockwise direction, at which point the oscillation stop 41 encounters the left flange 53 of the front frame stop 51. The sloped sides of the oscillation stop 41 may have flat surfaces that allow the oscillation stop 41 to form a flat interface with the flanges 53, 54 of the front frame stop 51 upon reaching the maximum rotation angle in either direction. Thus, a flat surface of the oscillation stop 41 may contact a corresponding flat surface of one of the flanges 53, 54, distributing the force of contact between the oscillation stop 41 and the flange 53, 54.

While the above-described examples include frame stops 49 on the front frame 13 of the vehicle 11 and articulation stops 35 present on the body of the hitch 21, as understood, the arrangement of these components may be reversed. In particular, one or more of the frame stops 49 may be present on the hitch 21, and one or more of the articulation stops 35, including deformable stoppers 39, may be present on the rear frame 15.

### INDUSTRIAL APPLICABILITY

The disclosed aspects of the hitch 21 of the present disclosure may be used to connect segments of a vehicle 11, such as front frame 13 and rear frame 15, while allowing oscillation and articulation of the segments relative to one another within predefined limits. The vehicle may be any vehicle that has segments that rotatably and pivotally couple. For example, the vehicle may be an articulating haul truck, such as those used in mining and excavation. In other examples, the vehicle may be a tractor, train, or other vehicle with multiple articulated segments, an associated trailer, etc.

The hitch 21 may include articulation stops 35 that limit the angular range through which the rear frame 15 may pivot relative to the hitch 21 and front frame 13. The articulation stops 35 may have deformable stoppers 39 that deform into the interior of the cavity 37 at the distal end 40 of the articulation stops 35 when depressed by the pivoting rear frame 15 (e.g., when the vehicle 11 makes a turn). As the deformable stoppers 39 depress into the cavity 37, they expand in a radially inward direction into a tapered opening 63 within the cavity 37, as well as in a radially outward direction. The expansion of the deformable stoppers 39 may be limited by contact with the walls of the cavity 37. The distal end 40 of the articulation stops 35 limits the deformation of the deformable stopper 39 by preventing over-compression by rear frame stop 49, protecting the deformable stopper 39 from damage. The deformation of the deformable stoppers 39 may dissipate the energy of the rear frame 15 as it pivots relative the front frame 13 and the hitch 21.

Oscillation stop 41 at the bottom end 28 of the hitch 21 may limit the relative rotation, or oscillation, of the rear frame 15 relative to the front frame 13 (e.g., when the vehicle 11 traverses uneven terrain that causes the rear frame 15 to tilt relative to the front frame 13). The sloped lateral sides 42 of the oscillation stop 41 may provide a planar interface at which contact occurs between the oscillation stop 41 and the flanges 53 and 54 of the front frame stop 51. This interface may distribute the load between the oscillation stop 41 and the front frame stop 51.

The above-described hitch may reduce cost and increase durability. The articulation stops may, for example, reduce relative motion between vehicle segments, dissipate the energy of the vehicle segments during contact, and reduce wear. The stoppers may also provide increased durability and easy replacement. The stoppers may prevent direct contact between the segments of a vehicle in at least some cases, and prevent damage to the vehicle when contact between the segments does occur. The oscillation stop may provide an increased contact surface to effectively limit relative motion of the front and rear frames, and may be relatively simple to manufacture.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A hitch for a vehicle, the hitch comprising:
a first side;
a second side opposite the first side;
a circular opening between the first side and the second side;
a first axis extending perpendicular to the circular opening;
a first articulation stop on the second side of the hitch and extending from the hitch, parallel to the axis;
a cavity within the first articulation stop, the cavity defining a floor; and
a deformable stopper within the cavity extending away from the floor of the cavity past a distal end of the first articulation stop,
wherein the deformable stopper is configured to deform within the cavity.

2. The hitch of claim 1, wherein the cavity is cylindrical in shape and has a longitudinal second axis that is parallel to the first axis.

3. The hitch of claim 2, wherein the deformable stopper is frustoconical in shape and centered about the longitudinal second axis, with an outer radius of the deformable stopper decreasing from a proximal end of the deformable stopper to a distal end of the stopper.

4. The hitch of claim 3, wherein a distal portion of the deformable stopper has a tapered opening about the second longitudinal axis, and the radius of the opening increases from a proximal end to a distal end of the tapered opening.

5. The hitch of claim 1, wherein a proximal portion of the deformable stopper forms a base having a central bore aligned with a longitudinal axis of the articulation stop.

6. The hitch of claim 1, wherein less than half of a total length of the deformable stopper extends past the distal end of the articulation stop and outside of the cavity.

7. The hitch of claim 1, wherein the hitch further comprises a second articulation stop spaced from the first articulation stop, the second articulation stop having a second cavity and a second deformable stopper.

8. The hitch of claim 1, wherein the deformable stopper is made of an elastomer.

9. The hitch of claim 1, wherein the stopper is removably coupled to the first articulation stop.

10. A hitch for connecting a front frame of a vehicle to a rear frame of the vehicle, the hitch comprising:
a first side;
a second side opposite the first side;
a circular opening between the first side and the second side;
a first axis extending perpendicularly to circular opening;
first and second pivot mounts;
first and second steering mounts;
an oscillation stop extending outward from the hitch with respect to the circular opening;
first and second articulation stops on the second side of the hitch and extending away from the hitch, parallel to the axis;
first and second cavities within the first and second articulation stops, respectively; and
first and second deformable stoppers within the respective cavities, the first and second deformable stoppers each extending away from an interior floor of the respective cavity past a distal end of the corresponding articulation stop,
wherein the first and second deformable stoppers are configured to deform within the respective cavities when depressed.

11. The hitch of claim 10, wherein the first cavity is sized such that, when the rear frame contacts a distal end of the first articulation stop, the first deformable stopper is fully contained within the first cavity.

12. The hitch of claim 10, wherein when the first deformable stopper is deformed within the first cavity, the first deformable stopper is configured to deform radially inward and radially outward within the first cavity when compressed.

13. The hitch of claim 10, wherein the oscillation stop is shaped as a wedge that extends radially away from the circular opening.

14. The hitch of claim 10, wherein the oscillation stop protrudes away from the circular opening in a direction that is perpendicular to the first axis.

15. The hitch of claim 10, wherein oscillation stop has sides that are tapered to form a flat contact surface with a frame stop on the first frame when the hitch is rotated.

16. The hitch of claim 10, wherein the hitch is configured to connect to a front frame, via a mount tube, when in a first position and configured to connect to a rear frame, via the mount tube, when in a second position that is offset from the first position by 180 degrees.

17. A vehicle comprising;
a first frame;
a second frame;
a hitch rotatably coupled to the first frame and pivotally coupled to the second frame, the hitch including:
a first side;
a second side opposite the first side;
a circular opening between the first side and the second side;
a first axis extending perpendicular to circular opening;
first and second pivot mounts;
first and second steering mounts; and
an oscillation stop extending radially outward from the hitch, the oscillation stop having sloped sides configured to form contact surfaces with the vehicle; and
an articulation stop configured to limit pivoting movement of the first frame relative to second rear frame.

18. The vehicle of claim 17, wherein the sloped sides of the oscillation stop include flat surfaces.

19. The vehicle of claim 18, further including:
a cavity defining a floor of the articulation stop; and
a deformable stopper within the cavity extending away from the floor of the cavity past a distal end of the articulation stop.

20. The vehicle of claim 19, wherein the deformable stopper includes a base and a distal end, the base having a thickness that is greater than a thickness of the distal end of the deformable stopper.
